(19) United States
(12) Patent Application Publication
(10) Pub. No.: US 2012/0159373 A1
(43) Pub. Date: Jun. 21, 2012

(54) SYSTEM FOR AND METHOD OF GENERATING DOG EAR BOOKMARKS ON A TOUCH SCREEN DEVICE

(75) Inventors: Don ARCHER, Euless, TX (US); Anil Kumar YANAMANDRA, Andhra Pradesh (IN)

(73) Assignee: VERIZON PATENT AND LICENSING, INC., Basking Ridge, NJ (US)

(21) Appl. No.: 12/968,600

(22) Filed: Dec. 15, 2010

(51) Int. Cl. G06F 3/048

(52) U.S. Cl. 715/776

(57) ABSTRACT

A system for and method of generating dog ear bookmarks on a touch screen device. The system and method may include receiving, on a touch screen device, input data from a user of the touch screen device, determining whether a dog ear event has occurred based on the input data, and generating, on the touch screen device, a graphical representation of a dog ear bookmark based on a determination that the dog ear event has occurred.

### BACKGROUND INFORMATION

In general, the use of electronic reader devices is increasing rapidly. Many electronic reader devices, however, offer limited features directed towards enhancing a user's experience with an electronic reader device. Accordingly, manufacturers of electronic reader devices are continuously adding new features directed towards such enhancements.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a bookmark system according to a particular embodiment;

FIG. 2 is a schematic diagram of hardware components of a dog ear bookmark system of a particular embodiment;

FIG. 3A illustrates an exemplary screen displaying input data associated with a dog ear event according to a particular embodiment;

FIG. 3B illustrates another exemplary screen displaying input data associated with the dog ear event according to a particular embodiment;

FIG. 3C illustrates another exemplary screen displaying input data associated with the dog ear event according to a particular embodiment;

FIG. 3D illustrates another exemplary screen displaying input data associated with the dog ear event according to a particular embodiment;

FIG. 4A illustrates an exemplary screen displaying input data associated with a dog ear event according to a particular embodiment;

FIG. 4B illustrates another exemplary screen displaying input data associated with the dog ear event according to a particular embodiment;

FIG. 4C illustrates another exemplary screen displaying input data associated with the dog ear event according to a particular embodiment;

FIG. 4D illustrates another exemplary screen displaying input data associated with the dog ear event according to a particular embodiment;

FIG. 4E illustrates another exemplary screen displaying input data associated with the dog ear event according to a particular embodiment;

FIG. 4F illustrates another exemplary screen displaying input data associated with the dog ear event according to a particular embodiment;

FIG. 5 is a flowchart illustrating the functionality of a particular embodiment; and

FIG. 6 is another flowchart illustrating the functionality of a particular embodiment.

### DETAILED DESCRIPTION OF PREFERRED EMBODIMENTS

Currently, users of electronic reader devices (e.g., Amazon's Kindle, Barnes and Noble's Nook) create bookmarks using multi-step processes that are overly cumbersome and time consuming. One such multi-step process may involve a user accessing a bookmark list before a bookmark is created. Another multi-step step process may involve a user inputting (e.g., typing in) a bookmark name before a bookmark is created. Such multi-step processes significantly reduce the ease of use and efficiency of current electronic reader devices.

Dog ear bookmarks may be seamlessly and quickly generated on electronic devices (e.g., touch screen devices) using a bookmark system. A bookmark system may couple a touch screen display device (e.g., a capacitive touch screen), an electronic device (e.g., an electronic reader device), and a dog ear bookmark system such that input data (e.g., a touch from a user's finger) is received via the touch screen display device and processed using the dog ear bookmark system.

A user may input data to create a dog ear bookmark on an electronic page of an electronic book by performing a dog ear bookmark gesture on the touch screen display device of the electronic device. A dog ear bookmark gesture may be start with a page-turn movement that stops shortly after the corner of an electronic page curls and end with a downward pressing movement (e.g., toward the touch screen display device). A page-turn movement may involve a user dragging a finger across a touch screen display device from side-to-side. Such a page-turn movement may initiate a page-turning animation that starts by curling the top or bottom corner of an electronic page until the electronic page is turned and the next electronic page is displayed on the touch screen display device.

Based on the input data received, the dog ear bookmark system may determine whether a dog ear event (e.g., the receipt of input data that indicates the performance of a dog ear bookmark gesture on an electronic page of an electronic book) has occurred. If, for example, the dog ear bookmark system determines that a dog ear event has occurred, a graphical representation of a dog ear bookmark may be outputted on an electronic page of an electronic book displayed on the touch screen display device. The dog ear bookmark system may also store dog ear bookmark information (e.g., the location of the dog ear bookmark, the time the dog ear bookmark was created, the user that created the dog ear bookmark) associated with the dog ear bookmark. If, however, the dog ear bookmark system determines that a dog ear event has not occurred, the dog ear bookmark system may continue to poll for input data that indicates that a dog ear event has occurred.

In one embodiment, determining whether a dog ear event has occurred may include calculating any, or a combination, of an average pressure, a maximum pressure, and a current pressure. An average pressure may be a pressure amount (e.g., an approximate pressure amount) that indicates the average amount of pressure detected while a user was inputting data during one or more past page-turn movements. A maximum pressure may be a pressure amount (e.g., an approximate pressure amount) that indicates the maximum amount of pressure detected by a touch screen display device. A current pressure may be a pressure amount (e.g., an approximate pressure amount) that indicates the amount of pressure detected when a user stops a current page-turn movement.

In another embodiment, determining whether a dog ear event has occurred may include determining whether the user has performed a two-finger dog ear bookmark gesture. In such an embodiment, a two-finger dog ear bookmark gesture may be detected by recognizing an input path (e.g., the way the touch screen display device is touched) associated with a user's input data.

In another embodiment, determining whether a dog ear event has occurred may include determining whether the user has performed a one-finger dog ear bookmark gestured. In such an embodiment, a one-finger dog ear bookmark gesture may be detected by recognizing an input path (e.g., the way the touch screen display device is touched) associated with a user's input data. A one-finger dog ear bookmark gesture may include tracing the path of a two-finger dog ear bookmark gesture with one finger (instead of two).

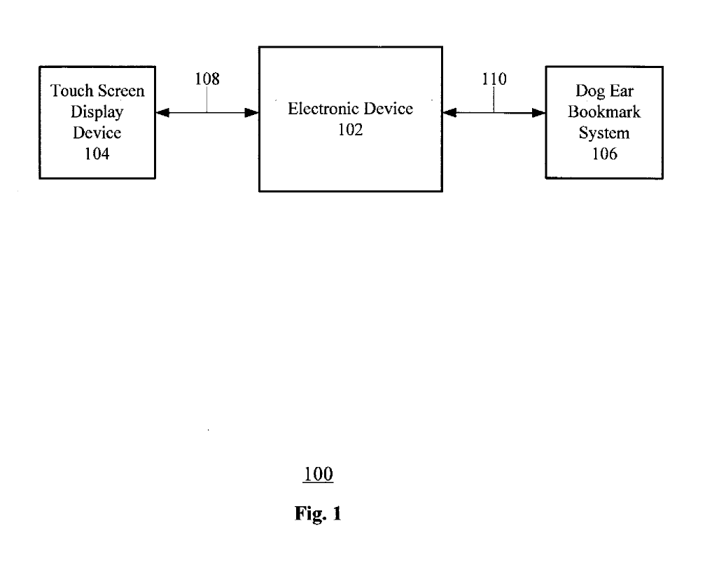

FIG. 1 is a schematic diagram illustrating a bookmark system according to a particular embodiment. In one embodiment, the bookmark system 100 may include a touch screen display device 104, an electronic device 102, and a dog ear bookmark system 106. The electronic device 102 may receive input data from the touch screen display device 104 via bidirectional data path 108 and transmit the input data to the dog ear bookmark system 106 via bidirectional data path 110. It should be noted that the touch screen display device 104, the electronic device 102, and the dog ear bookmark system 106 may be independent of each other or integrally connected to each other.

The touch screen display device 104 may be communicatively coupled to electronic device 102 via bidirectional data path 108. In one embodiment, the touch screen display device 104 may include software, hardware, or a combination of both, configured to receive input data from a user using one or more touch screen mechanisms. For example, touch screen display device 104 may receive input data or any other data from the user via the one or more touch screen mechanisms. In another embodiment, the touch screen display device 104 may include software, hardware, or a combination of both, configured to transmit data received (e.g., input data) to the electronic device 102 or the dog ear bookmark system 106 via data path 108. In yet another embodiment, the touch screen display device 104 may include software, hardware, or a combination of both, configured to display electronic content (e.g., electronic newspapers, electronic magazines, electronic books).

The electronic device 102 may be communicatively coupled to the touch screen display device 104 via bidirectional data path 108 and the dog ear bookmark system 106 via bidirectional data path 110. In one embodiment, the electronic device 102 may include software, hardware, or a combination of both, configured to receive input data or any other data from touch screen display device 104 and transmit the input data to dog ear bookmark system 106.

In another embodiment, the electronic device 102 may include software, hardware, or a combination of both, configured to receive, process, and facilitate display of electronic content. For example, the electronic device 102 may be an electronic reader device.

The dog ear bookmark system 106 may be communicatively coupled to the electronic device 102 and the touch screen display device 104 via bidirectional data path 110. The dog ear bookmark system 106 may include software, hardware, or a combination of both, configured to receive input data or any other data from touch screen display device 104 or electronic device 102. The dog ear bookmark system 106 may include software, hardware, or a combination of both configured to determine if a dog ear event has occurred based on the input data received. The dog ear bookmark system 106 is described in further detail below.

One or more data paths disclosed herein may include any device that communicatively couples one or more devices to each other. For example, one or more data paths may include one or more networks or one or more conductive wires (e.g., copper wires). Data paths 108, 110 are illustrated and described as bidirectional for illustration purposes. It should be noted that one or more data paths illustrated in FIG. 1 may be unidirectional or bidirectional.

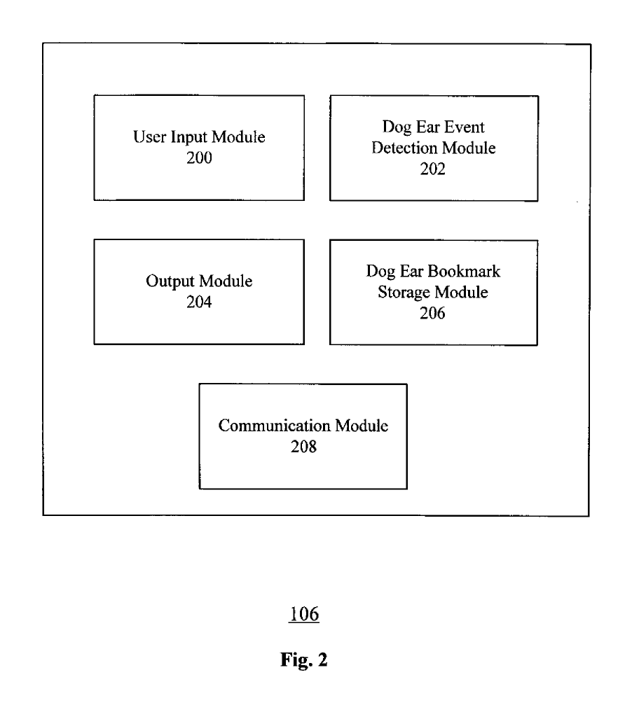

FIG. 2 is a schematic diagram of hardware components of a dog ear bookmark system of a particular embodiment. The dog ear bookmark system 106 may include a user input module 200, a dog ear event detection module 202, an output module 204, a dog ear bookmark storage module 206, and a communication module 208. It is noted that the modules 200, 202, 204, 206, and 208 are exemplary. The functions of the modules 200, 202, 204, 206, and 208, may be performed at other modules remote or local to the dog ear bookmark system 106, and the modules 200, 202, 204, 206, and 208 may be combined or separated.

The communication module 200 may include computer-implemented software, hardware, or a combination of both, configured to receive input data from the touch screen display device 104 or the electronic device 102 via data path 110. In one embodiment, the communication module 208 may be configured to communicate input data received to one or more other modules of the dog ear bookmark system 106, such as: the user input module 200, the dog ear event detection module 202, the output module 204, and the dog ear bookmark storage module 206. In one embodiment, the communication module 208 may be configured to communicate one or more messages received from the other modules to one or more other modules.

The output module 204 may include computer-implemented software, hardware, or a combination of both, configured to output electronic content (e.g., electronic book, paginated content) on the touch screen display device 104. Based on input data received from a user, the output module 204 may allow the user to turn an electronic page of the electronic book by performing a page-turn movement. Once a page-turn movement is detected, the output module 204 may output the next electronic page of the electronic book.

The user input module 200 may include computer-implemented software, hardware, or a combination of both, configured to receive input data from a user using the touch screen display device 104. In one embodiment, input data may include data that indicates that the user is performing a page-turn movement. In another embodiment, input data may include data that indicates that a dog ear event has occurred.

The dog ear event detection module 202 may include computer-implement software, hardware, or a combination of both, configured to determine whether a dog ear event has occurred based on the input data received. The dog ear event detection module 202 may determine whether a dog ear event has occurred by determining whether the input data received indicates the performance of a dog ear bookmark gesture by the user on an electronic page of an electronic book. In one embodiment, a dog ear bookmark gesture may start with a page-turn movement that stops shortly after the corner of an electronic page curls and end with a downward pressing movement (e.g., toward the touch screen display device 104).

In one embodiment, the dog ear event detection module 202 may determine whether a dog ear event has occurred by calculating an average pressure, a maximum pressure, and a current pressure. An average pressure may be a pressure amount (e.g., an approximate pressure amount) that indicates the average amount of pressure detected while a user was inputting data during one or more past page-turn movements. A maximum pressure may be a pressure amount (e.g., an approximate pressure amount) that indicates the maximum amount of pressure detected by a touch screen display device. A current pressure may be a pressure amount (e.g., an approximate pressure amount) that indicates the amount of pressure detected when a user stops a current page-turn movement. If, for example, the current pressure calculated is greater than half of the difference between the maximum pressure and the average pressure, the dog ear event detection module 202 may determine that a dog ear event has occurred. If, however, the current pressure calculated is less than half of the difference between the maximum pressure and the average pressure, the dog ear event detection module 202 may determine that a dog ear event has not occurred.

In another embodiment, the dog ear event detection module 202 may determine whether a dog ear event has occurred by detecting whether a two-finger dog ear bookmark gesture has been performed by a user on an electronic page of an electronic book. In such an embodiment, the dog ear event detection module 202 may detect a two-finger dog ear bookmark gesture by recognizing an input path (e.g., the way the touch screen display device is touched) associated with a user's input data.

Based on a determination that a dog ear event has occurred, the output module 204 may output one or more dog ear creation indicators (e.g., visual indicators, tactile indicators, audible indicators). For example, the output module 204 may output (e.g., display) a graphical representation of a dog ear bookmark on the electronic page displayed on the touch screen display device 104 to indicate the creation of a dog ear bookmark. In another example, the output module 204 may output a vibration to indicate the creation of a dog ear bookmark. In yet another example, the output module 204 may output a sound (e.g., a soft paper-wrinkle sound) to indicate the creation of a dog ear bookmark.

The dog ear bookmark storage module 206 may include computer-implement software, hardware, or a combination of both, configured to store dog ear bookmark information associated with each dog ear bookmark created. In one embodiment, dog ear bookmark information may include the location of the dog ear bookmark (e.g., the electronic page and the electronic book on which the dog ear bookmark is created), the time the dog ear bookmark was created, the user that created the dog ear bookmark (e.g., the user logged into electronic device 102 at the time the dog ear bookmark is created). In another embodiment, dog ear bookmark information may be automatically added to a list of bookmarks in a navigational area of the electronic device 102 once a dog ear bookmark is created.

A user may tap a dog ear bookmark (e.g., using a finger) to remove the dog ear bookmark from an electronic page of an electronic book. The dog ear bookmark information associated with the removed dog ear bookmark may be deleted from the dog ear bookmark storage module 206.

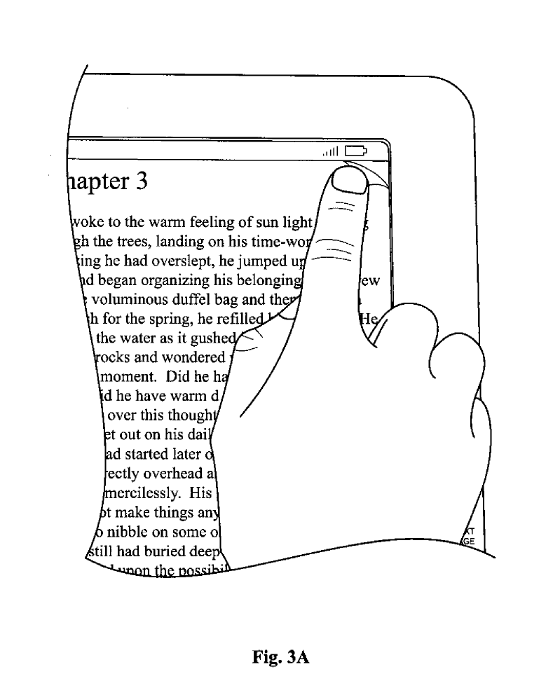

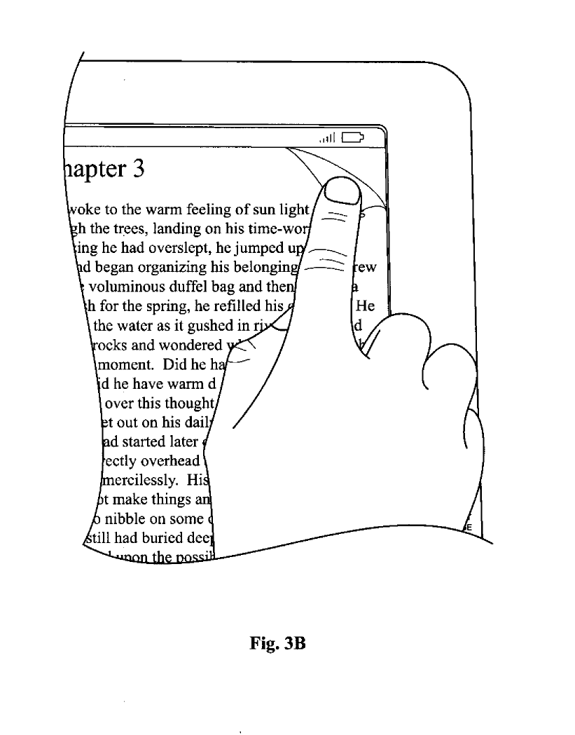

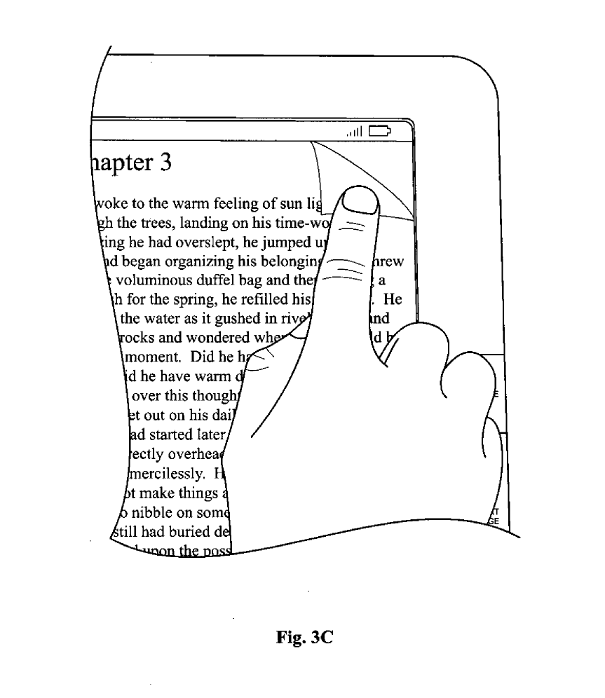

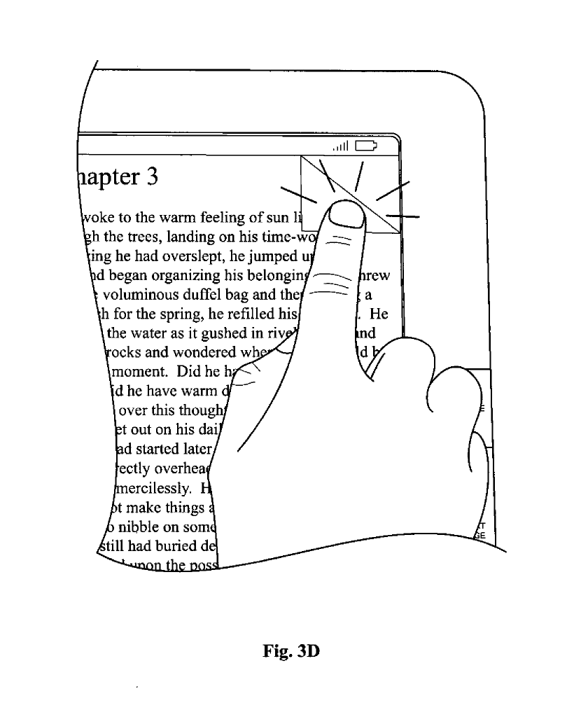

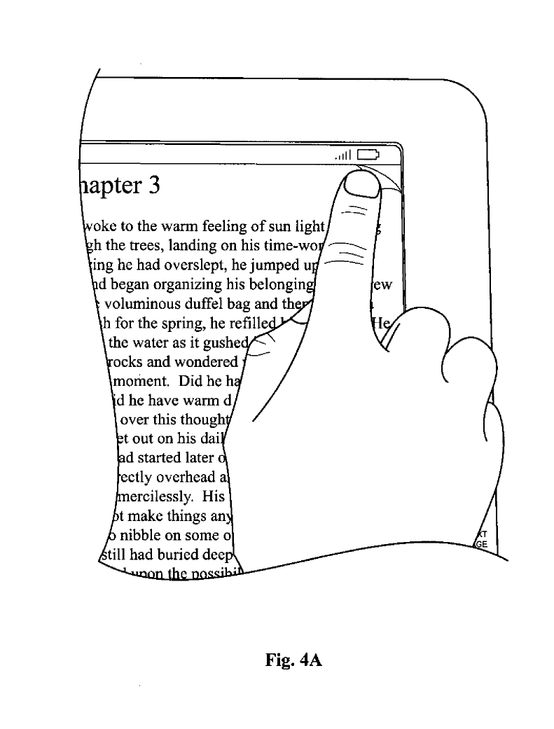

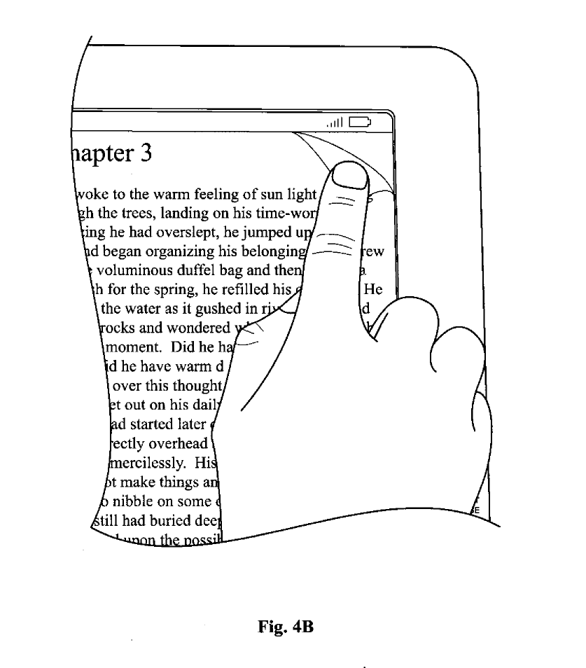

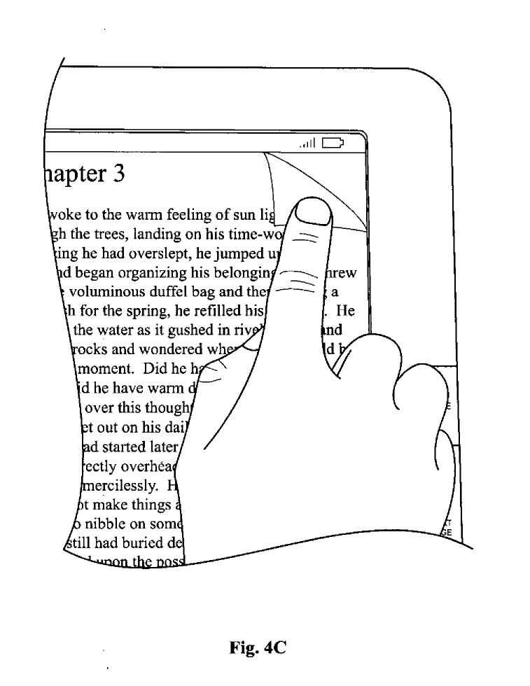

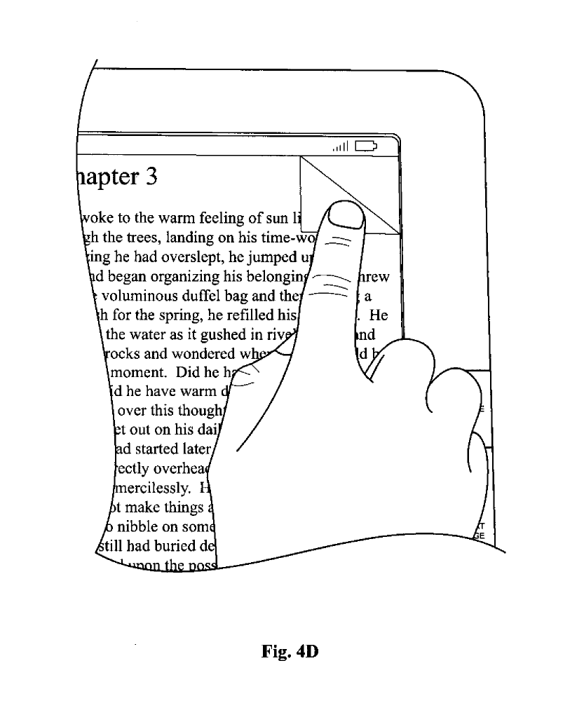

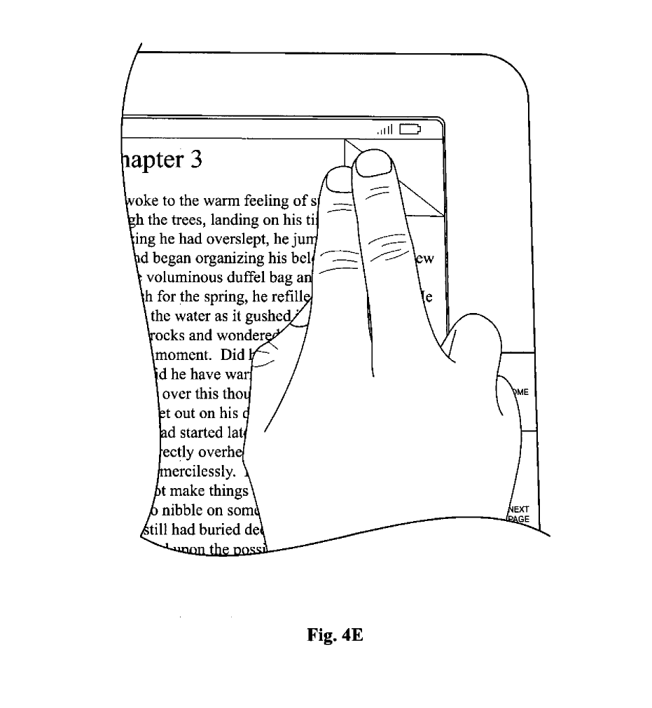

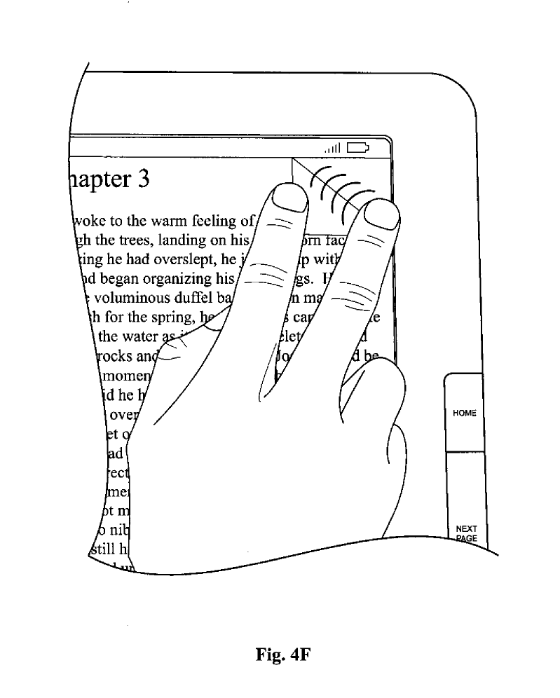

FIGS. 3A-3D may illustrate a dog ear bookmark gesture. FIGS. 4A-4F may illustrate a two-finger dog ear bookmark gesture.

FIG. 3A illustrates an exemplary screen displaying input data associated with a dog ear event according to a particular embodiment. As illustrated in FIG. 3A, a dog ear bookmark gesture may start with a page-turn movement that initiates a page-turning animation. The page-turning animation may start by curling the top or bottom corner of an electronic page (as the user drags a finger across the corner) until the electronic page is turned and the next electronic page is displayed on the touch screen display device (e.g., touch screen display device 104).

FIG. 3B illustrates another exemplary screen displaying input data associated with the dog ear event according to a particular embodiment. As illustrated in FIG. 3B, the dog ear bookmark gesture may continue as the top corner of the electronic page curls as the user continues to drag a finger from the corner across the top of the touch screen display device (e.g., touch screen display device 104).

FIG. 3C illustrates another exemplary screen displaying input data associated with the dog ear event according to a particular embodiment. As illustrated in FIG. 3C, the dog ear bookmark gesture may stop shortly after the corner of the electronic page curls as the user stops dragging a finger across the top of the touch screen display device (e.g., touch screen display device 104).

FIG. 3D illustrates another exemplary screen displaying input data associated with the dog ear event according to a particular embodiment. As illustrated in FIG. 3D, the dog ear bookmark gesture may end with the user performing a downward pressing movement (e.g., toward the touch screen display device). As a result of the performance of the dog ear bookmark gesture, a dog ear bookmark may be created on the current electronic page displayed on the touch screen display device (e.g., touch screen display device 104).

FIG. 4A illustrates an exemplary screen displaying input data associated with a dog ear event according to a particular embodiment. As illustrated in FIG. 4A, a two-finger dog ear bookmark gesture may start with a page-turn movement that initiates a page-turning animation. The page-turning animation may start by curling the top or bottom corner of an electronic page (as the user drags a finger across the corner) until the electronic page is turned and the next electronic page is displayed on the touch screen display device (e.g., touch screen display device 104).

FIG. 4B illustrates another exemplary screen displaying input data associated with the dog ear event according to a particular embodiment. As illustrated in FIG. 4B, the two-finger dog ear bookmark gesture may continue as the top corner of the electronic page curls as the user continues to drag a finger from the corner across the top of the touch screen display device (e.g., touch screen display device 104).

FIG. 4C illustrates another exemplary screen displaying input data associated with the dog ear event according to a particular embodiment. As illustrated in FIG. 4C, the two-finger dog ear bookmark gesture may stop shortly after the corner of the electronic page curls as the user stops dragging a finger across the top of the touch screen display device (e.g., touch screen display device 104).

FIG. 4D illustrates another exemplary screen displaying input data associated with the dog ear event according to a particular embodiment. As illustrated in FIG. 4D, the two-finger dog ear bookmark gesture may hold one finger on the curled portion of the electronic page displayed on the touch screen display device (e.g., touch screen display device 104).

FIG. 4E illustrates another exemplary screen displaying input data associated with the dog ear event according to a particular embodiment. As illustrated in FIG. 4E, the two-finger dog ear bookmark gesture may press a second finger on the curled portion of the electronic page displayed on the touch screen display device (e.g., touch screen display device 104).

FIG. 4F illustrates another exemplary screen displaying input data associated with the dog ear event according to a particular embodiment. As illustrated in FIG. 4F, the two-finger dog ear bookmark gesture may drag the second finger across the crease of the curled portion of the electronic page displayed on the touch screen display device (e.g., touch screen display device 104). As a result of the performance of the two-finger dog ear bookmark gesture, a dog ear bookmark may be created on the current electronic page displayed on the touch screen display device.

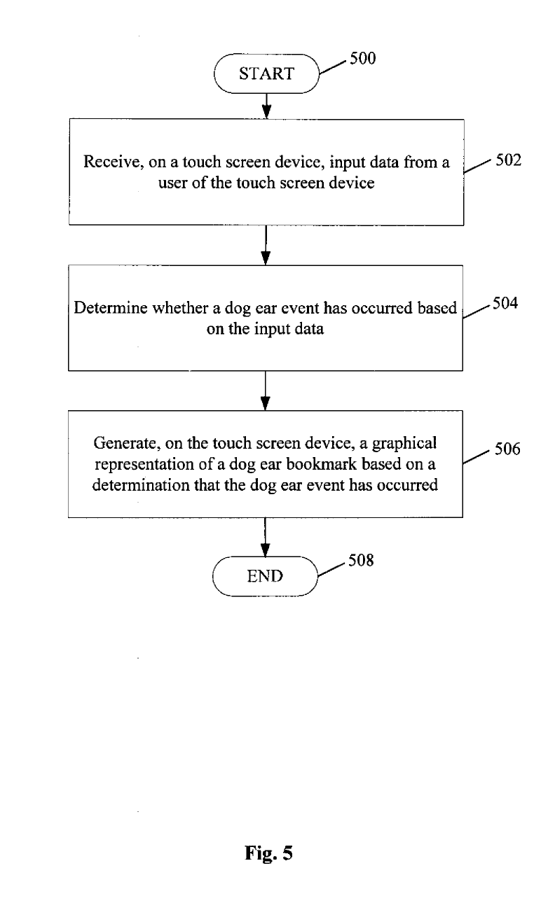

FIG. 5 is a flowchart illustrating the functionality of a particular embodiment. This exemplary method is provided by way of example, as there are a variety of ways to carry out methods disclosed herein. The method shown in FIG. 5 may be executed or otherwise performed by one or a combination of various systems. The method is described below as carried out by the dog ear bookmark system 106 shown in FIG. 1 by way of example, and various elements of the dog ear bookmark system 106 are referenced in explaining the example method. Each block shown in FIG. 5 represents one or more processes, methods, or subroutines carried out in the exemplary method. Referring to FIG. 5, the exemplary method may begin at block 500.

In block 502, the method may include receiving, on a touch screen device, input data from a user of the touch screen device. In one embodiment, the user input module 200 of the dog ear bookmark system 106 may receive input data from a user of the touch screen device (e.g., an electronic reader device). The method may continue to block 504.

In block 504, the method may include determining whether a dog ear event has occurred based on the input data. In one embodiment, the dog ear detection module 202 of the dog ear bookmark system 106 may determine whether a dog ear event has occurred based on the input data. In one embodiment, the dog ear detection module 202 may determine whether a dog ear event has occurred by determining whether a dog ear bookmark gesture or a two-finger dog ear bookmark gesture has been performed on an electronic page of an electronic book displayed on the touch screen device (e.g., touch screen display device 106). The method may continue to block 506.

In block 506, the method may include generating, on the touch screen device, a graphical representation of a dog ear bookmark based on a determination that the dog ear event has occurred. In one embodiment, the output module 204 of the dog ear bookmark system 106 may generate a graphical representation of a dog ear bookmark based on a determination that the dog ear event has occurred. The method may then end at block 508.

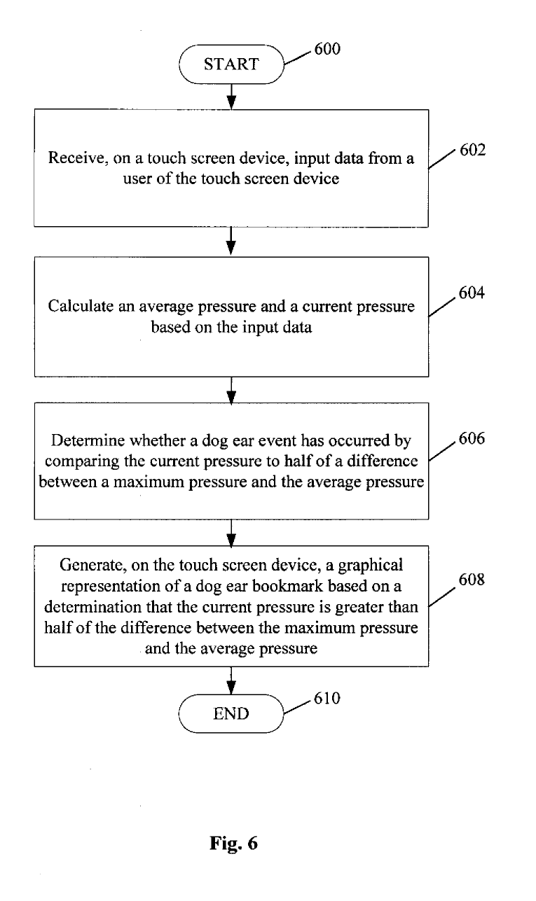

FIG. 6 is another flowchart illustrating the functionality of a particular embodiment. This exemplary method is provided by way of example, as there are a variety of ways to carry out methods disclosed herein. The method shown in FIG. 6 may be executed or otherwise performed by one or a combination of various systems. The method is described below as carried out by the dog ear bookmark system 106 shown in FIG. 1 by way of example, and various elements of the dog ear bookmark system 106 are referenced in explaining the example method. Each block shown in FIG. 6 represents one or more processes, methods, or subroutines carried out in the exemplary method. Referring to FIG. 6, the exemplary method may begin at block 600.

In block 602, the method may include receiving, on a touch screen device, input data from a user of the touch screen device. In one embodiment, the user input module 200 of the dog ear bookmark system 106 may receive input data from a user of the touch screen device (e.g., an electronic reader device). The method may continue to block 604.

In block 604, the method may include calculating an average pressure and a current pressure based on the input data. In one embodiment, the dog ear detection module 202 of the dog ear bookmark system 106 may calculate an average pressure and a current pressure based on the input data. The method may continue to block 606.

In block 606, the method may include determining whether a dog ear event has occurred by comparing the current pressure to half of a difference between a maximum pressure and the average pressure. In one embodiment, the dog ear detection module 202 of the dog ear bookmark system 106 may determine whether a dog ear event has occurred by comparing the current pressure to half of a difference between a maximum pressure and the average pressure. The method may continue to block 608.

In block 608, the method may include generating, on the touch screen device, a graphical representation of a dog ear bookmark based on a determination that the current pressure is greater than half of the difference between the maximum pressure and the average pressure. In one embodiment, the output module 204 of the dog ear bookmark system 106 may generate, on a touch screen device, a graphical representation of a dog ear bookmark based on a determination that the current pressure is greater than half of the difference between the maximum pressure and the average pressure. The method may then end at block 610.

The description above describes systems and networks that may include one or more modules, some of which are explicitly shown in the figures. As used herein, the term “module” may be understood to refer to any, or a combination, of computer executable computing software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system, comprising:
a user input computing apparatus configured to receive, on a touch screen device, input data from a user of the touch screen device;
a dog ear event detection computing apparatus configured to determine whether a dog ear event has occurred based on the input data; and
an output computing apparatus configured to generate, on the touch screen device, a graphical representation of a dog ear bookmark based on a determination that the dog ear event has occurred.

2. The system of claim 1, wherein the touch screen device comprises an electronic reader device.

3. The system of claim 1, wherein the output computing apparatus is further configured to display, on the touch screen device, an electronic page of an electronic book.

4. The system of claim 1, wherein the dog ear event detection computing apparatus is further configured to determine whether a dog ear event has occurred by calculating a current pressure based on the input data.

5. The system of claim 4, wherein the dog ear event detection computing apparatus is further configured to determine whether a dog ear event has occurred by determining whether the current pressure exceeds a threshold.

6. The system of claim 1, wherein the dog ear event detection computing apparatus is further configured to determine whether a dog ear event has occurred by calculating an average pressure.

7. The system of claim 1, wherein the dog ear event detection computing apparatus is further configured to determine whether a dog ear event has occurred by determining whether a dog ear bookmark gesture was made based on the input data.

8. The system of claim 1, wherein the output computing apparatus is further configured to output, from the touch screen device, a sound based on the determination that the dog ear event has occurred.

9. The system of claim 1, wherein the output computing apparatus is further configured to output, from the touch screen device, a vibration based on the determination that the dog ear event has occurred.

10. A method, comprising:
receiving, on a touch screen device, input data from a user of the touch screen device;
determining whether a dog ear event has occurred based on the input data; and
generating, on the touch screen device, a graphical representation of a dog ear bookmark based on a determination that the dog ear event has occurred.

11. The method of claim 10, wherein the touch screen device comprises an electronic reader device.

12. The method of claim 10, further comprising displaying, on the touch screen device, an electronic page of an electronic book.

13. The method of claim 10, wherein determining whether a dog ear event has occurred further comprises calculating a current pressure based on the input data.

14. The method of claim 13, wherein determining whether a dog ear event has occurred further comprises determining whether the current pressure exceeds a threshold.

15. The method of claim 10, wherein determining whether a dog ear event has occurred further comprises calculating an average pressure.

16. The method of claim 10, wherein determining whether a dog ear event has occurred further comprises determining whether a dog ear bookmark gesture was made based on the input data.

17. The method of claim 10, further comprising outputting, from the touch screen device, a sound based on the determination that the dog ear event has occurred.

18. The method of claim 10, further comprising outputting, from the touch screen device, a vibration based on the determination that the dog ear event has occurred.

19. The method of claim 10, further comprising storing dog ear bookmark information based on the determination that the dog ear event has occurred.

20. A computer readable media comprising code to perform the acts of the method of claim 10.
